(19) United States
(12) Patent Application Publication
(10) Pub. No.: US 2002/0126673 A1
(43) Pub. Date: Sep. 12, 2002

(54) Shared memory

(76) Inventors: Nirav Dagli, Placentia, CA (US); Paul Wang, San Clemente, CA (US)

Correspondence Address: Chad W. Miller, Weide & Associates, Ltd., Phoenix Bldg., 11th Floor, Suite 1130, 330 South 3rd Street, Las Vegas, NV, 89101, US

(21) Appl. No.: 09/759,485

(22) Filed: Jan. 12, 2001

(51) Int. Cl. H04L 12/28

(52) U.S. Cl. 370/392; 370/412

(57) ABSTRACT

A system and method for tracking data using a sharing memory is disclosed. In one embodiment the system comprises a plurality of queues, each configured to track the order of receipt of data items. The plurality of queues utilize a shared memory instead of associating memory with each queue. Memory addresses are dynamically allocated and de-allocated based on the needs of each queue. As a queue utilizes all its originally assigned addresses, additional memory addresses may be allocated to the queue. Likewise, as a queue outputs its contents, unused memory addresses are de-allocated so the addresses may be used by other queues. In one embodiment, the addresses are allocated in blocks by a block identifier comprising a single memory address. One or more counters in each queue increments and decrements the block identifier to access different memory locations. In one embodiment each queue includes an order tracking module to track the order of receipt of each data item based on the address at which the data item is stored.

### FIELD OF THE INVENTION

The present invention relates to memory utilization and in particular to a method and apparatus for an efficient memory sharing system.

### BACKGROUND OF THE INVENTION

There is a continuing desire to increase the speed and efficiency of computer and network devices while at the same time reducing costs. One technology area where this is true is in computer networking devices. In general, computer networking products process large numbers of data items, packets, packet identifiers, or other data to facilitate computer operation or computer networking. It is desired to processes packets, and the associated data, overhead or accounting information (hereinafter collectively ‘data items’) as quickly as possible while taking up as little space as possible, consuming as little power as possible with equipment costing as little as possible.

One example of an operation that occurs in a computer networking device is receipt, storage, and classification of data, such as packets in a packet switched network. It is often desirable to classify the received packets or other associated data into groups based on common characteristics such as class of service, size of the data, transmit priority, input or output port or any other aspect.

In addition, it may be desired to track the order of receipt of a packet or other data in a computer network processing device. Although numerous methods and apparatus exit to monitor or track order or receipt, one method comprises use of a plurality of queues. Queues may be used to store the packets, or a packet identifier or other data associated with the packet such that as a packet is received, it or its associated data may be placed in a queue. The items in the queue are thus maintained in order based on placement into the queue thereby providing an ability to remove the items or data stored in the queue in the order in which they were placed in the queue.

While using a plurality of queues allows a system to store and track the order of receipt of a plurality of items, it also has drawbacks. One drawback arises when the number of the data items to be stored and/or the number of queue increases. This causes the amount of memory required for operation to increase to an undesirably large amount. For example, there may exist 50 queues, with each queue configured to store up to 50,000 data items. Each data item may require 128 bits. This system thus requires 50 queues×50,000 items/queue×128 bits/item. This requires 320,000,000 bits of memory space. This is the same as 40,000,000 bytes of memory.

A system with such a large amount of memory suffers from numerous drawbacks. One drawback is the cost associated with such a large amount of memory. Another drawback is that such a large amount of memory draws undesirably large amounts of power. Another drawback is that such a large amount of memory takes up an undesirably large amount of space.

The size of this much memory is itself a hindrance because it leads to configurations that place the memory distant from the memory controller or the queue controller. Reading and writing the data to distant memory may cause unwanted read/write errors and thus hinder desired operation. As a result it may be necessary to reduce the speed at which the read/write operations occur, which in turn undesirably slows system operation.

Hence, there is a need for a system that more efficiently queues data items in computerized devices, such as a networking device.

### SUMMARY OF THE INVENTION

The invention provides a method and apparatus for queue operation with a shared memory. It is contemplated that the invention as interpreted broadly may be implemented in various configurations to reduce the total amount of memory required to provide storage space for items stored or tracked by a plurality of queues. The invention overcomes the disadvantages of the prior art by providing a shared memory that provides for a single memory to be shared by a plurality of queues, such as first-in, first-out type queues. By providing a shared memory in a system configured to store a known number of data items, such as packets, the amount of memory required for system operation may be reduced as compared to systems of the prior art. No longer is a memory with adequate capacity associated with each queue. Memory having adequate capacity is defined as memory with sufficient space to concurrently store the maximum number of data items that may be concurrently processed by the device.

In one example embodiment packets are received by a packet processing device. There is a known number of packets that may be stored or processed by the packet processing device at any one time. As a packet is received, it is evaluated so that it may be assigned to a particular queue for storage until a transmit opportunity is available for the received packet. Packets may be assigned to various queues to establish drop priorities and transmit priorities for the packets. One example of a queue configured to perform packet tracking is a first-in, first-out (FIFO) structure.

Packets assigned to a particular queue are assigned a packet identifier or a memory space identifier. The packet identifier is tracked in the queue. The queue system, such as a FIFO may track the order of receipt and may establish an order of transmission. Packets sharing a common characteristic may be grouped in particular queues to provide drop capability based on packet characteristics.

Packets may be identified by a packet identifier. A packet identifier may include information regarding the size of the packet and the packet's location in a packet memory. Packet identifiers assigned to a particular queue may be stored in a memory shared by the plurality of queues. The packet identifier's memory location in the shared memory may be stored within the queue. The plurality of queues in the system store packet identifiers within the shared memory. Hence, a dedicated memory is not longer associated with each queue thereby reducing the total amount of memory required.

To transmit a packet from the packet processing device, a queue is selected or granted an opportunity to transmit. The queue queries itself, such as an internal FIFO for the next-out data. The next-out data stored in the queue FIFO contains packet information and the packet's location in memory, for example, an address. Using the packet's location in memory, the system retrieves the packet from the shared memory. The packet may thus be transmitted by the packet processing device.

Another advantage of the invention is that it may be configured to operate at high speed as compared to other memory systems, such as those of the prior art. By way of example, the queueing of data into a FIFO may utilize fast control logic systems that overcome the slow procedures carried out in software in the prior art. The invention also enjoys speed advantages because the reduced amount of memory required may be accessed more rapidly or, because less memory is required, a high speed memory may be utilized without affecting cost.

Further objects, features, and advantages of the present invention over the prior art will become apparent from the detailed description of the drawings which follows, when considered with the attached figures.

### DESCRIPTION OF THE DRAWINGS

FIG. 1 illustrates a block diagram of an example embodiment of the invention.

FIG. 2 illustrates a block diagram of an alternative embodiment of the invention.

FIG. 3 illustrates a flow diagram of an example method of writing data to a shared memory system.

FIG. 4 illustrates a flow diagram of an example method of reading data from a shared memory system.

### DETAILED DESCRIPTION OF THE INVENTION

The invention is a method and apparatus for memory utilization. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Moreover, while the invention is described below in conjunction with a packet processing device, it should be apparent to those of ordinary skill in the art that the invention is not limited to this particular example environment. The invention be implemented in any environment that would benefit from the efficient utilization of memory. Likewise, the invention may be used in other than queue environments. Any application that suffers from inclusion of redundant memory may benefit from the shared memory system of the invention.

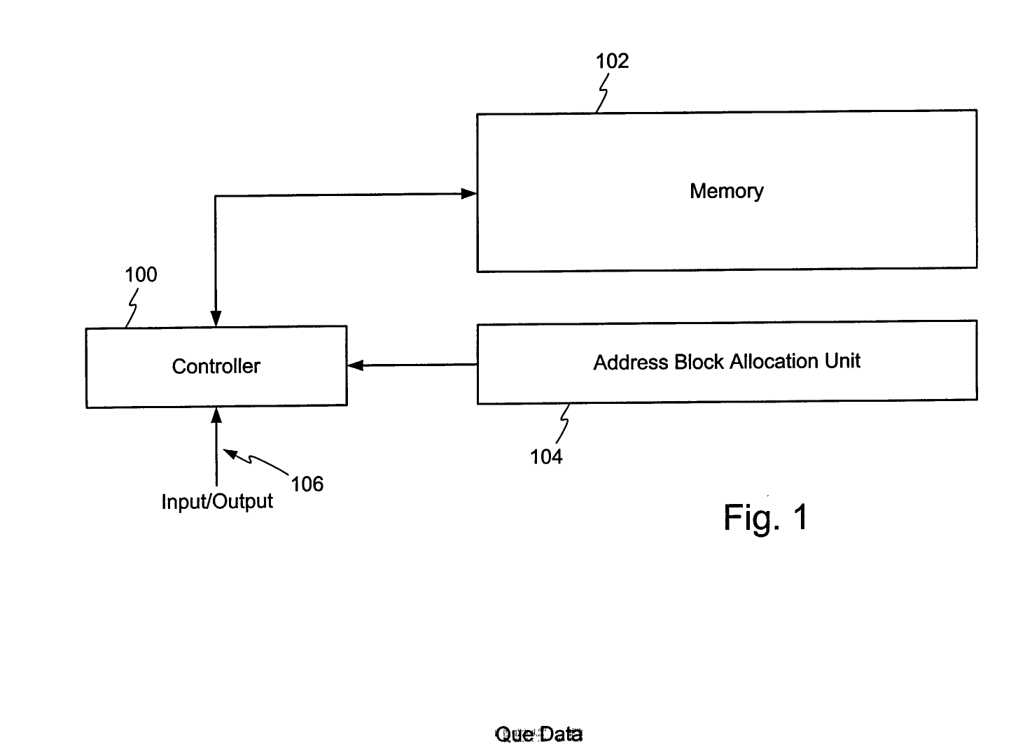

FIG. 1 illustrates a block diagram of an example embodiment of the invention. As shown, a controller 100 couples to a memory 102 and an address block allocation unit 104. The controller 100 also includes an input/output port 106. In this embodiment the controller 100 comprises logic and controller memory configured to receive one or more items of queue data for ordered storage until retrieval. In one embodiment a plurality of queues are located within the controller 100 and each queue is initially allotted a number of memory addresses at which to store queue data. Further, each queue may request memory addresses from the address allocation unit 104. In various different configurations the queue data may be stored in first-in, first-out order or some other order as may be desired. It is also contemplated that the controller 100 may include logic or other apparatus to evaluate the type of received queue data and selectively place the queue data into one of several queues or storage areas. In this manner the received queue data may be tracked based on order of receipt and based on type or priority of queue data. In another embodiment the type or priority of queue data is provided to the controller 100 and the controller need only track the order of receipt and store the queue data. Other methods or priorities for tracking queue data may be adopted.

The memory 102 is a shared memory structure used to store, in any order, the queue data received by the queue controller 100. It should be understood that the connections of FIG. 1 are for purposes of understanding and that a data bus, such as input/output 106, may connect directly to the memory 102 to facilitate data transfer under control of the controller 100. The memory 102 may comprise any type of memory including but not limited to SRAM, DRAM, RDRAM, or any other type of memory or RAM. The location and order tracking of the queue data in memory is the responsibility of the controller 100. It is contemplated that the memory be divided into a plurality of memory locations, each of which is identified by an address or slot number.

The address block allocation unit 104 facilitates use of the memory as shared memory. Upon request by the controller 100, the address block allocation unit 104 provides address information to the controller. In one embodiment the address information comprises an identifier representative of a block of addresses to memory locations, such as a sequential block of addresses in memory. In another embodiment the address information comprises a list of addresses to memory locations, while in another embodiment the address information comprises a single memory location address. Thus, in response to requests from the controller 100 the address block allocation unit 104 provides the controller 100 with one or more addresses to memory. Likewise, the controller 100 may return or provide back to the address block allocation unit 104 address information that is not in use or that becomes unused.

In operation, the controller 100 receives queue data. The controller 100 may processes the queue data to evaluate which of two or more queues in the controller to place the queue data. Alternatively, the queue is provided with queue placement information in conjunction with the receipt of the queue data. After determining which queue to assign the queue data, the controller 100 obtains an address from the next available address associated with the queue and stores the queue data at that location in shared memory 102 associated with the address. Thus, the queue data is stored at a memory location and the address at which it is stored is maintained in a desired order in the assigned queue.

If a queue maintained by the controller 100 does not have an address available, the controller requests a block of memory addresses from the address block allocation unit 104. The allocation unit 104 provides address information as an address identifier, a block of addresses, or other address information to the requesting queue in the controller. The requesting queue utilizes the first identified address to store queue data assigned to that queue in shared memory 102 at the location identified by the address. In another embodiment, the address request to the allocation unit 104 occurs at the end of a write operation if the write operation utilized the last available address for that queue.

After the queue data is stored in memory 102, the controller 100, in conjunction with the queue, maintains a record or tracking of the order of receipt of the queue data and where the queue data is located. At a later time, if the queue data is to be retrieved from the queue, such as when the queue is granted priority to transmit, the queue provides the memory address for the requested queue data so that the queue data maybe retrieved.

If the queue outputs so many items of queue data that it has a sufficient number of excess memory address, it returns a block of addresses to the allocation unit 104 so that the addresses contained in the returned block of addresses may be used by other queues that are part of the controller 100. In other embodiments the queue may return a block of addresses to the allocation unit whenever it has excess addresses. In this manner the memory 102 is shared between the various queues of the controller 100.

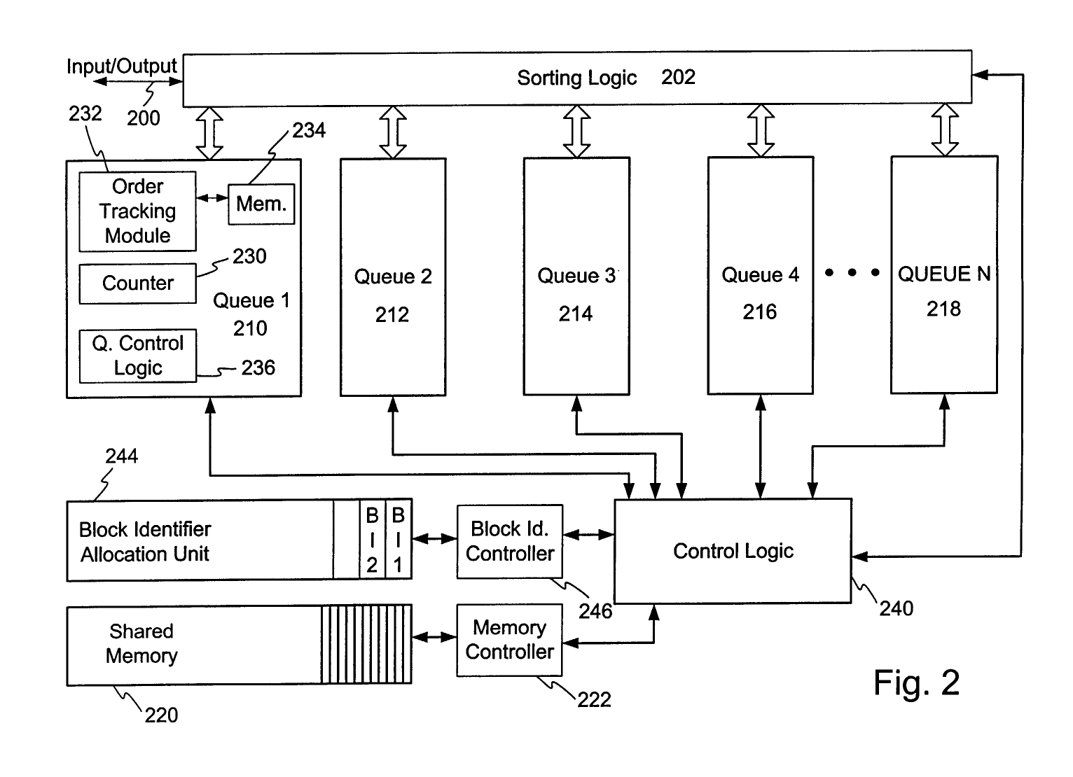

FIG. 2 illustrates an alternative embodiment of the invention. One example environment for this example embodiment is in a packet processing device, such as for example, a router in a computer network. A packet input/output line 200 communicates data, such as packets or packet information, (hereinafter queue data) to sorting logic 202 or other processing apparatus. The sorting logic 202 processes the incoming data to determine which queue to place the incoming queue data into or, in an alternative embodiment, may be provided information regarding which queue to place the data from another apparatus.

The sorting logic connects to a shared memory 220 via a memory controller 222. The shared memory 220 may comprise any form of memory capable of storing data, including but not limited to RAM, SRAM, DRAM, or RDRAM. The memory 220 is configured to receive and store data, such as queue data at memory locations defined by addresses, the addresses being provided by a queue.

As a result of the processing by the sorting logic, the incoming data or data identifier is channeled to a queue. This example embodiment includes queue1 210, queue2 212, queue3 214, queue4 216, and queueN 218 where N comprises any positive integer that is not already accounted for by queues 210, 212, 214, and 216. Thus, any number of queues may utilize the share memory 220 as contemplated by the invention. In this embodiment each queue 210-218 comprises a queue controller having address tracking capability and queue data tracking capability. For purposes of discussion, each queue may be initially and permanently configured with a block of addresses, each block containing a plurality of addresses the reference locations in the shared memory 220. In another embodiment the queues may start without any memory addresses assigned to them. Thus addresses would be obtained by request from the queue.

Queue1 210 is illustrated to show one configuration of components that may be internal to the queues 210-218. The queues should be thought of as controllers that utilize a shared memory 220 for storage of data. In one embodiment, the queue1 210 may include one or more counters 230 to increment and/or decrement address values, an order tracking module 232 and associated memory 234 to track and store the order of receipt of queue data, and various control logic 236 to oversee and guide operation of the systems of queue1 210. The control logic is understood by one or ordinary skill in the art to be interspersed amongst the apparatus of the queue and hence direct connections between the apparatus are not shown. The various apparatus of queue1 operate together as a queue and utilize a shared memory 220. Thus, in some instances the queue 210 may be thought of as a queue controller that interfaces with external systems, such as sorting logic 202, and tracks the order of receipt of items, while utilizing a shared memory 220. Operation of the queues 210-218 is described below. In one embodiment of the invention, the queues may each be considered to be a first-in, first-out (FIFO) structure.

The queues 210-218 also connect to control logic 240. The control logic 240 interfaces the queues 210-218 with block identifier allocation unit 244, via a block identifier allocation unit controller 246. The control logic 240 also interfaces the queues 210-218 with the shared memory 220, via a memory controller 222. Operation of the control logic 240 in conjunction with the other systems is described below in greater detail.

The shared memory 220 and memory controller 222 are configured to store data received from the sorting logic 202. The memory is divided into a plurality of locations, each location being identified by an address. Issuing data and a memory address to the memory controller 222, causes the data to be stored in memory 220 at the address provided. The data may be retrieved at a later time by providing the address to the memory controller 222 during a memory read operation. One example of the data is a packet identifier. In one example a packet identifier comprises information regarding a packet's location in memory and packet size information. Additional memory (not shown) may be provided to store the packet payload. Another example could be a packet or a part thereof.

The block identifier allocation unit 244 and the block identifier controller 246 operate to receive requests from the control logic 240 for a block of addresses to memory locations. In one embodiment the block of addresses comprise a block identifier that provides the first address in a block of sequential addresses. Thus, it can be understood that for a block of addresses A1000-A1100, only the identifier A1000 may be provided and subsequent addresses are known by incrementing the identifier A1000. Thus, a single block identifier may identify an entire block of addresses if the number of addresses in the block are known. In another embodiment the allocation unit 244 provides an entire block of memory addresses.

In one embodiment the block identifier allocation unit 244 comprises a first-in, first-out (FIFO) structure having a FIFO controller and memory. Upon receipt of a request for a block of addresses, the FIFO provides the next-out value from the FIFO to the control logic 240. The provided value may comprise an identifier to a block of addresses to memory.

Write Operation

In operation the sorting logic 202 receives queue data on the input/output line 200 and performs processing on queue data. The processing may comprise determining which queue to place or store the queue data. It should be understood that the sorting logic 202 also connects to the shared memory 220 and hence the sorting logic routes the queue data to shared memory while the queues and control logic determine which memory location to store the queue data.

Queue Operation

Exemplary operation of queue1 210 is now discussed. Upon determining which queue is responsible for tracking the queue data, the sorting logic signals the proper queue to provide an address, to the control logic 240 at which to store the data. After the sorting logic 202 selects and notifies the receiving queue of the data to be queued, the receiving queue, in this example queue1 210, obtains the next address in its block of addresses. At startup, each queue is assigned a block of addresses. In one embodiment this comprises one thousand addresses. As data is assigned to a queue 210, the addresses in the queue's first block of addresses are used up. This fills the memory locations identified by each used address.

In one embodiment, the address provided by the queue is the output value of a queue counter 230. The queue 210 arrives at the next address in the block of addresses by incrementing the counter 230 and outputting the results of the incremented counter to the queue control logic 236. The counter 230 output represents the next memory address in the block of addresses assigned to the queue.

The queue 210 then outputs the address to the control logic 240 and utilizes an internal order tracking module 232, such as a FIFO, to track the order that addresses were assigned. In this way the queue operates as a first-in, first-out device by also being able to output addresses in the same order as the addresses were used.

If the address provided by the queue 210 to the control logic 240 is the last address in an address block that was assigned to the queue, the queue may request another block of addresses. Thus, if there are no addresses available, the queue 210 signals the control logic 240 that it is out of unoccupied addresses. In turn the control logic 240 requests a block of addresses from the block allocation unit 244. To satisfy the request, the block allocation unit 244 provides a block of addresses to the queue via the control logic 240. In one embodiment the allocation unit 244 provides a block identifier that the queue 210 uses to calculate or determine the other addresses in the provided block of addresses. For example, if it is known that each block comprises 100 addresses, the allocation unit 244 may provide a single address to the queue 210, such as to the queue counter 230, and the queue counter may sequentially increment or decrement the address to track the next address.

Shared Memory Operation

After the queue 210 provides the address to the control logic 240, the control logic writes the corresponding data received from the sorting logic 202 to the shared memory 220 at the location specified by the address from the queue. This process repeats among the plurality of queues 210-218 thereby sharing the memory 220 between the queues as needed by each queue. This provides the advantage of reducing the total memory required for system operation assuming that the total number of elements to be stored by the system of FIG. 2 is fixed or does not exceed the memory space. A single memory 220 with capacity to store the total number of queue data items that the system is intended to process may be used. One example of a data item is a packet.

Read Operation

The read operation is generally similar to the write operation described above. When a read request occurs, queue data is to be retrieved from memory 220. In one embodiment it is preferred to retrieve the queue data from memory 220 in the same order as it was received, i.e. written to the queue. Thus, each queue 210-218 may operate as a FIFO. The sorting logic 202 receives a read request and signals the proper queue 210-218 to read its next-out data. The queue 210 utilizes the order tracking module 232 to retrieved the next-out address stored therein and provides it to the control logic 240. The control logic 240 provides the address to the memory 220, 222 to retrieve the data stored at the location specified by the memory address. The memory controller 222 provides the data to the sorting logic 202 or other system requesting the data.

After the queue 210 provides the address to the control logic 240 to retrieve the data, the queue returns the address to the block of addresses it was assigned so that it may be used again by the queue. This may occur by decrementing the counter 230. If the return of the address to the block of addresses at the queue results in an entire block of addresses plus an extra address from the previous block not being used by the queue, then the queue 210 transfers the block of addresses back to the block identifier allocation unit 244. The block identifier allocation unit 244 stores the block of addresses. Thus, the allocation unit 244 assigns blocks of addresses to the various queues as needed and receives unused blocks of addresses. Thus, the memory 220 serves as a shared memory because memory addresses are assigned as needed and subsequently returned. When another queue has used all its available addresses and requests a block of addresses from the allocation unit 244 the allocation unit may provide the requesting queue with a block of addresses previously returned from another queue. In one embodiment the allocation unit 244 and controller 246 comprise a FIFO structure configured so that as the blocks of addresses are returned and allocated, the memory 220 is used in a generally even usage pattern.

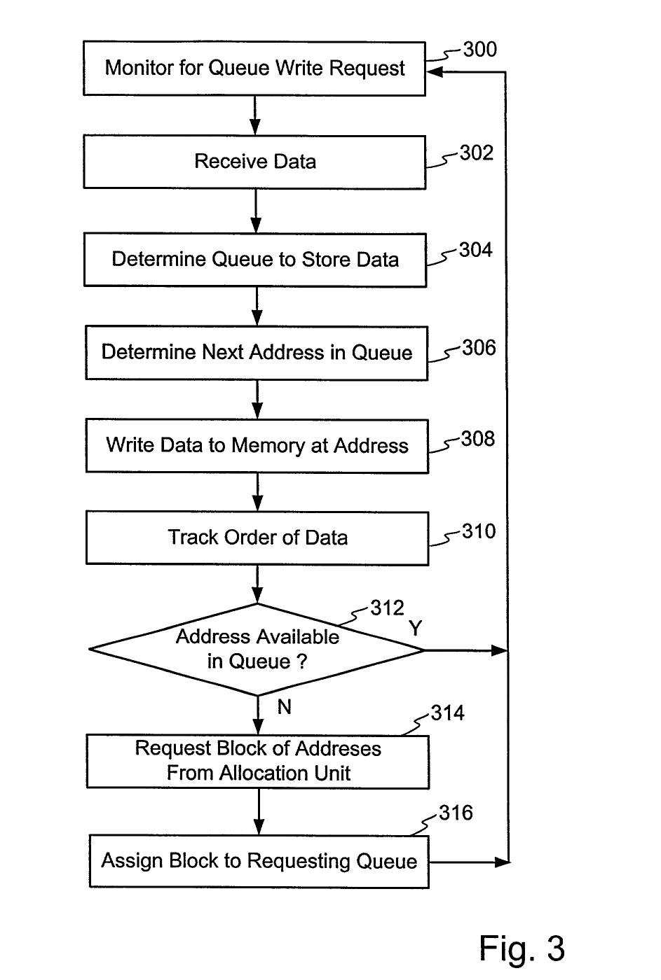

FIG. 3 illustrates an operational flow diagram of an example method of writing data. At a step 300 the operation of the shared memory system monitors for a write request to memory. Upon detection a request to write to memory, the shared memory system receives the data. This occurs at a step 302. The data can comprise any type of data to be stored in a queue system. Next, at a step 304 the shared memory system may determine which queue of the two or more different queues to store the data. In one embodiment which queue to store the data is provided to the shared memory system.

After the proper queue to store the data is determined, the designated queue of the shared memory system obtains the next address assigned to it. This occurs at a step 306. In one embodiment this occurs by incrementing a counter to increment an address represented by the counter output. It is contemplated that each queue be assigned a number of addresses or one block of addresses at start-up. The queue utilizes these memory location addresses to store data. The queue may request additional memory addresses if it fills all the memory locations corresponding to the addresses it was initially assigned.

Next, at a step 308 the system writes the data to shared memory at the location identified by the address provided by the queue. Thus, the data is stored in a memory location and may be retrieved at a later time. At a step 310 the order of use of the address or the order of storage or receipt of the data is tracked. Other aspects may be tracked. In one embodiment tracking the order comprises storing the address in a tracking FIFO that is part of the queue. The tracking FIFO operates as a standard FIFO by providing on its output the data item stored in the FIFO for the longest period.

After the data is stored in memory, the queue determines if there are additional addresses available for use in the queue, such as to accommodate additional data being assigned to the queue for storage. If at step 312 there are additional addresses available, the queue does not require additional addresses and the operation returns to step 300 to monitor for a write request.

If at step 312 there are not any additional addresses at the queue to store incoming data to the queue, then the operation progresses to a step 314. At step 314, the operation requests a block of addresses. In one embodiment the request is made to a FIFO containing block identifiers. The queue uses the block identifier to arrive at or calculate the various addresses of the block. After the block is requested, the operation progresses to a step 316 and the system delivers or assigns the block of addresses to the queue. The block of addresses may be provided by providing a block identifier. After the block is assigned to the queue, the operation returns to step 300 wherein the system monitors for a write request.

This is but one exemplary write operation patterned in accordance with the shared memory of the invention. It is fully contemplated that other methods of operation may be enabled without departing from the scope of the invention.

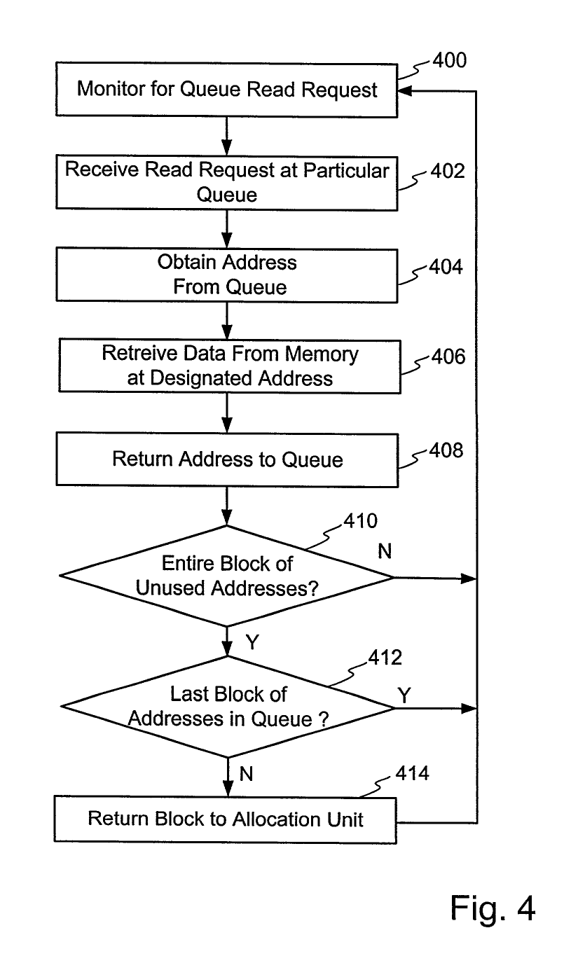

FIG. 4 illustrates an operational flow diagram of an example method of reading data. At a step 400 the operation of the shared memory systems monitors for a read request to read data from memory. At a step 402, the shared memory system receives a request to read from memory. In one embodiment the request comprises an authorization to transmit data assigned to a particular queue or a designation of which queue of the two or more queues to select for the next transmit opportunity. The data can comprise any type of data to be stored in a queue system. Next, at a step 404 the system obtains the address from the queue that was designated to have transmit priority. In one embodiment the address is obtained by requesting the next-out entry in an order tracking module, such as a FIFO, in the designated queue.

After the address is identified or obtained at the designated queue, the address is forwarded to the memory, such as to the memory controller and the data is retrieved from memory. This occurs at a step 406. After the data is retrieved from memory, the operation, at a step 408, returns the address to the queue for use by the queue when the queue is requested to store additional items in memory. In one embodiment the apparatus that generates the address or stores the address is one or more counters configured to increment or decrement their value in response to read or write operations. In this manner, the address is automatically incremented or decremented as data is written to the queue and read from the queue.

Next, at a decision step 410, the operation determines whether an entire block of addresses are unused. This determination is made to determine if a queue possesses excess addresses and hence to determine if a block of addresses may be returned to the allocation unit for use by other queues. Thus, at step 410, a determination is made regarding if a sufficient number of addresses are unused by the queue to warrant returning one or more addresses to the address allocation unit. In one embodiment there must be an entire block of addresses plus an extra address that is not in use by the queue before a block of addresses will be returned. If at step 410 a determination is made that less than a block of unused addresses are available, then the operation returns to step 400 and the system continues to monitor for a queue read request.

Alternatively, if at decision step 410, the operation determines that an entire block of addresses are available, then the operation progresses to a decision step 412. At step 412, the operation determines if the excess block of addresses is the last block. In one embodiment each queue is permanently assigned a block of addresses that remain with the queue. Thus, if the block is the last block then the operation returns to step 400 and the operation monitors for a queue read request. If at step 412 it is determined that the excess block is not the last block, the operation progresses to a step 414. At step 414, the operation returns the block of addresses for use by other queues. In one embodiment returning the block of addresses comprises returning a block identifier in the form of a single address to an allocation unit embodied as a FIFO. After the block is returned to the allocation unit, the operation returns to step 400 wherein the system monitors for a queue read request.

Example Implementation

In one example implementation, the shared memory system is embodied in a packet routing device. In an example implementation of a routing device, assume the system has a total of 256 queues, each queue supports 64,000 packets, and each queue entry is allotted 4 bytes of memory space. In one embodiment adopting the teachings of the invention, the router supports 64,000 packets, which can be distributed between the various queues. Hence, the memory is shared by the queues. In contrast to the teachings of the invention, systems of the prior art use the following equations to define the total amount of memory required to support the 256 queues.

$${Memory}_{total} = ( \# of Queues ) \times ( \frac{Entries}{Queue} ) \times ( \frac{Memory}{Entry} )$$

which, for the above prior art system, requires:

memoryₜₒₜₐₗ=(256)×(64,000)×(4 bytes)

memoryₜₒₜₐₗ=65,536,000 bytes

This is an undesirably large amount of memory and would be difficult to implement for numerous reasons, some of which are recited above.

Using the teachings of the invention, a system having 256 queues with up to 64,000 entries per queue and 4 bytes per entry may be implemented with substantially less memory. The memory is divided into slots, and each memory slot is accessed by a group of addresses. Each group of addresses is defined as a block. In this example implementation each block comprises 1,000 addresses and each address accesses a 4 bytes of memory. Hence, each block of addresses allows a queue to store 1,000 items in memory. Assuming each queue is permanently assigned one block of memory addresses that can store 1,000 items with 4 bytes per items, and there are 256 queues, then the permanent assignment requires 1,024,000 bytes of memory. The following equations re-state this.

memoryₚₑᵣₘₐₙₑₙₜ=(#ofQueues)×(blocksₚₑᵣₘₐₙₑₙₜ)×(bytes/block)

memoryₚₑᵣₘₐₙₑₙₜ=256×1,000 entries/slot

memoryₚₑᵣₘₐₙₑₙₜ=256,000 entries

memory_{float}=63×1 k entries

Next, memory space must be provided for the 64,000 items to be processed by the system. Since one block has already been assigned to each queue, there is a need for additional memory space for up to 63,000 items in the shared memory. This assumes a worst case scenario wherein every item is assigned to a single queue. Since each item is a maximum size of 4 bytes, there should be 63,000 items×4 bytes/item or 252,000 bytes of additional memory space. This is defined as:

memory_{float}=63×1 k entries

Adding this amount of shared memory with the amount of permanently assigned memory equals 1,276,000 total bytes needed for system memory and can be defined as:

memoryₜₒₜₐₗ=memoryₚₑᵣₘₐₙₑₙₜ+memory_{float}

This is significantly less than the approximately 65 million bytes of memory required for a prior art system.

A similar calculation may be performed for a packet processing system configured with 512 queues. In the prior art, the system would require about 131,072,000 bytes of memory. In contrast, a shared memory system according to the invention would only require about:

$$\begin{matrix}{memory}_{total} = [ 512 queues ] \times [ 4 \frac{bytes}{item} ] \times [ 1000 \frac{items}{{queue}_{perm}} ] + \\ [ 63 , 000 \times 4 \frac{bytes}{item} ] \\ {memory}_{total} = [ 2 , 048 , 000 bytes ] + [ \text{252,000} bytes ] \\ {memory}_{total} = 2 , 300 , 000 bytes\end{matrix}$$

memoryₜₒₜₐₗ=[2,048,000 bytes]+[252,000 bytes]

memoryₜₒₜₐₗ=2,300,000 bytes

As can be seen this is a substantial memory savings over the prior art.

This is but one example method of implementation of the system. It is contemplated that the teachings of the shared memory as described herein may be implemented in a variety of different ways without departing from the scope of the invention. Similarly, will be understood that the above described arrangements of apparatus and the method therefrom are merely illustrative of applications of the principles of this invention and many other embodiments and modifications may be made without departing from the spirit and scope of the invention as defined in the claims. The features of the invention may be embodied alone or in any combination.

We claim:

1. A method for packet queueing in a packet processing device comprising:
receiving a packet;
analyzing the packet to determine a designated queue for the packet;
generating a packet identifier based on the analyzing;
associating an address to a shared memory with the packet identifier;
storing the packet identifier in the shared memory at the associated address; and
storing the associated address in the designated queue.

2. The method of claim 1, wherein storing the associated address in the designated queue comprises loading the associated address in a first-in, first-out device.

3. The method of claim 1, wherein analyzing the packet comprises analyzing type of service information.

4. The method of claim 1, wherein a queue comprise a controller and a first-in, first-out device.

5. The method of claim 1, further including evaluating if an address is available.

6. The method of claim 1, wherein the packet identifier stored in the designated queue comprises the associated address and information regarding the packet length.

7. A method for tracking data items:
assigning data items one or more designations of a plurality of designations;
for each designation, obtaining and assigning a memory address, the address corresponding to a location in a shared memory;
tracking each assignment of designation of data items;
storing a record of each designation and assigned memory address in the shared memory at the obtained memory address, wherein the shared memory stores a plurality of assignments of designations.

8. The method of claim 7, wherein assigning data items one or more designations comprises assigning the data items to one or more queues of a plurality of queues.

9. The method of claim 7, wherein tracking comprises tracking order of receipt of at least one data item.

10. The method of claim 7, wherein the memory is divided into a plurality of locations.

11. The method of claim 7, further including deleting one or more records from the shared memory if the shared memory is full.

12. The method of claim 7, further including manipulating data items based on the designation and the tracking.

13. The method of claim 12 wherein the manipulating data items comprises actions selected from the group consisting of deleting, transmitting and performing processing on.

14. A shared memory and plurality of queues configured for use in a data item processing device comprising:
a shared memory configured to store at least one data item identifier, the memory having memory locations defined by memory addresses;
a plurality of queues, at least one queue configured to track the order of receipt of at least one data item identifier assigned thereto by storing memory addresses; and
control logic configured to initiate storage of at least one data item identifier in shared memory based on an evaluation of the data item identifier or the data item identified by the data item identifier and assign memory address at which data items are stored to one or more queues.

15. The shared memory of claim 14, wherein the shared memory stores a plurality of data item identifiers that identify data items that are assigned to various of the plurality of queues.

16. The shared memory of claim 14, each queue comprises a first-in, first-out memory structure.

17. The shared memory of claim 14, further including a memory address allocation unit in communication with the control logic and the plurality of queues, the memory address allocation unit configured to provide a memory address to at least one queue or the control logic.

18. The shared memory of claim 17, wherein the memory address allocation unit comprises a first-in, first-out memory structure.

19. The shared memory of claim 14, further including transmit logic configured to obtain a memory address from a queue and initiate retrieval of a data item identifier from shared memory.

20. A queue system configured to utilize a shared memory comprising:
a shared memory, wherein items stored in shared memory are identified by a memory address;
two or more first-in, first-out queues;
an address allocation unit configured to allocate memory addresses;
a controller configured to:
receive and analyze packet data corresponding to a packet;
request an address from the allocation unit;
associate the address with a packet identifier;
assign the address to one or more of the queues based on the analysis of packet data; and
initiate storage of the packet identifier in shared memory at the address associated with the packet identifier.

21. The system of claim 20, wherein the system is configured to track the order of receipt of packets in a computer network router.

22. The system of claim 20, wherein the shared memory is configured to store 64,000 packet identifiers.

23. The system of claim 20, wherein the address allocation unit comprises a first-in, first-out device loaded with at least one memory addresses.

24. The controller of claim 20, wherein each memory address identifies an identical size memory location.

25. A first-in, first-out queue system having a shared memory comprising:
a controller configured to receive a packet, assigned the packet to a transmit priority queue, and store the packet in a first memory at a packet address;
at least one transmit priority queue having order tracking system and an allocation unit interface, wherein the at least one transmit priority queue is configured to store the packet address in a shared memory;
a shared memory configured to store received packet addresses at memory locations in the shared memory; and
an allocation unit configured to interface with the at least one transmit priority queue to allocate memory addresses for the shared memory to the at least one transmit priority queue.

26. The system of claim 25, wherein the allocation unit comprises a first-in, first-out memory structure containing memory addresses to the shared memory.

27. The system of claim 25, wherein the shared memory comprises RAM.

28. The system of claim 25, wherein the transmit priority queues comprise first-in, first-out devices.

29. The system of claim 25, further including a transmit module configured to select one of at least one transmit priority queue from which to transmit, the transmit module obtaining a memory address from the selected queue to obtain information regarding the location of a packet to be transmitted.

30. A method of transmitting information identified by a next-out item from a queue, the queue utilizing a shared memory comprising:
designating a queue with transmit priority;
requesting a next-out item from the designated queue, the next-out item identifying a memory address to a shared memory;
retrieving the data item stored in the shared memory at the memory address identified by the next-out item from the queue; and
transmitting information stored at a location identified by the data item.

31. The method of claim 30, wherein the next-out item comprises an address to shared memory.

32. The method of claim 30, wherein the next-out item comprises at least a memory address and the information comprises a packet.

33. The method of claim 30, wherein the queue stores queue items that identify information that shares a similar attribute.

34. The method of claim 30, wherein next-out items comprise an address to shared memory, data items comprise addresses to where information is stored in a second memory, and the shared memory stores data items.

35. The method of claim 30, wherein the method designates from a plurality of queues, the plurality of queues sharing the shared memory to store data items to thereby reduce the total amount of memory required.
